(19) United States
(12) Patent Application Publication
(10) Pub. No.: US 2014/0279758 A1
(43) Pub. Date: Sep. 18, 2014

(54) COMPUTATIONAL METHOD FOR PREDICTING FUNCTIONAL SITES OF BIOLOGICAL MOLECULES

(71) Applicant: ACADEMIA SINICA, TAIPEI (TW)

(72) Inventors: An-Suei Yang, Taipei (TW); Hung-Pin Peng, Taipei (TW); Jhih-Wei Jian, Taipei (TW)

(73) Assignee: ACADEMIA SINICA, TAIPEI (TW)

(21) Appl. No.: 14/215,163

(22) Filed: Mar. 17, 2014

Related U.S. Application Data
(60) Provisional application No. 61/792,380, filed on Mar. 15, 2013.

(51) Int. Cl. G06F 19/12; G06F 17/30; G06F 19/24

(52) U.S. Cl. CPC G06F 19/12; G06F 19/24; G06F 17/30598
USPC 706/12; 707/737; 707/736; 706/52

(57) ABSTRACT

In a general aspect, a method for inferring one or more biomolecule-to-biomolecule interaction sites includes receiving data representative of a plurality of prediction models. Each prediction model is associated with a different atom type of a plurality of atom types and characterizes biomolecule-to-biomolecule interaction site specific patterns common to a plurality of three dimensional probability density maps. Each three dimensional probability density map is associated with a corresponding biomolecule of a plurality of biomolecules included in a training data set and represents a probability of a non-covalent interacting atom on a surface of the corresponding biomolecule interacting with the atom type associated with the prediction model. Data representative of a query biomolecule is received, the data including one or more unknown biomolecule-to-biomolecule interaction sites. The one or more unknown biomolecule-to-biomolecule interaction sites of the query biomolecule are inferred based on the data representative of the plurality of prediction models.

### CROSS-REFERENCE TO RELATED APPLICATIONS

The present application claims the benefit of U.S. Provisional Patent Application Ser. No. 61/792,380, which was filed on Mar. 15, 2013, by An-Suei Yang et al. for a A COMPUTATIONAL METHOD FOR PREDICTING FUNCTIONAL SITES OF BIOLOGICAL MOLECULES and is hereby incorporated by reference.

### BACKGROUND OF THE INVENTION

1. Field of the Invention

This disclosure relates to computation biology and in particular to computational methods for predicting functional sites of biological molecules based on three dimensional probability density maps of interacting atoms.

2. Background Information

Biological molecules such as proteins bind to other molecules at functional sites. For example, such sites can be protein to protein interaction (PPI) sites, protein to carbohydrate interaction sites, or more generally as biomolecule-to-biomolecule interaction sites. Computational predictions of the biomolecule-to-biomolecule interaction sites can provide insights into the biological functions of biomolecules which are critical in identifying key targets for therapeutics development. To date, genomics projects have generated around 10 million distinct sequences, and the next generation sequencing technologies promise the evermore drastically improved throughput rate and reduced cost in genomics sequencing. High throughput x-ray crystallography, on the other hand, has generated a large number of non-redundant protein structures, leading to the development where the structures of an increasingly large portion of the protein sequences of unknown structures and unknown function from genomics and proteomics studies can be modeled reasonably well with computational homology modeling: Currently, the structures of ˜40% of genomic sequences have been computationally modeled to at least medium resolution, providing around 20 million model structures in the public domain databases. Nevertheless, the functions of only ˜1% of the genomics sequences have been characterized experimentally.

### SUMMARY OF THE INVENTION

Provided is a method for inferring one or more biomolecule-to-biomolecule interaction sites comprising receiving data representative of a plurality of prediction models, each prediction model associated with a different atom type of a plurality of atom types and characterizing biomolecule-to-biomolecule interaction site specific patterns common to a plurality of three dimensional probability density maps, each three dimensional probability density map associated with a corresponding biomolecule of a plurality of biomolecules included in a training data set and representative of a probability of a non-covalent interacting atom on a surface of the corresponding biomolecule interacting with the atom type associated with the prediction model; receiving data representative of a query biomolecule including one or more unknown biomolecule-to-biomolecule interaction sites; inferring the one or more unknown biomolecule-to-biomolecule interaction sites of the query biomolecule based on the data representative of the plurality of prediction models.

A method is also provided for generating prediction models for prediction of biomolecule-to-biomolecule interaction sites, the method comprising receiving training data including data representative of a plurality of biomolecules having known biomolecule-to-biomolecule interaction sites;

for each biomolecule of the plurality of biomolecules

generating a plurality of three dimensional probability density maps, each three dimensional probability density map representing a probability of a non-covalent interacting atom on a surface of the biomolecule interacting with a corresponding atom type of a plurality of atom types;

for each surface atom of a plurality of surface atoms of the biomolecule, calculating a plurality of attributes, each attribute associated with a different one of the plurality of atom types;

training a prediction model for each of the atom types of the plurality of atom types based on the attributes calculated for each biomolecule of the plurality of biomolecules.

Additionally, provided is a method for determining clusters of amino acid conformations, the method comprising:

for each protein of a plurality of proteins in a protein database:

for each amino acid type of a plurality of amino acid types: determining data characterizing a conformation of each instance of the amino acid type in the protein including

determining a vector of torsion angle elements for each instance of the amino acid type in the protein; and processing the data characterizing the conformation determined for each instance of each type of amino acid for each protein in the protein database to identify clusters of amino acid instances having similar conformation characteristics.

In another aspect, a method is provided for building a protein atomistic non-covalent interacting database, the method comprising:

for each protein of a plurality of proteins in a first protein database:
Identifying non-covalent interacting atom pairs at the protein interior;
for each atom of each identified pair of non-covalent interacting atoms:
   determining data representative of an amino acid type associated with the atom, a conformational type associated with the atom, an atom type associated with the atom, an interacting atom type associated with the atom, and a spatial relationship between the atom and each of the interacting atom types; storing the data in the protein atomistic non-covalent interacting database;

for each protein of a plurality of proteins in a second protein database:

determining data representative of water oxygen distributions around surface amino acids of the protein; and

storing the data in the protein atomistic non-covalent interacting database. for each protein of a plurality of proteins in a protein-interacting partner database:
identifying non-covalent interacting atom pairs where the pairs include an atom at the protein surface and an atom in an interacting partner;
for each atom of each identified pair of non-covalent interacting atoms:
determining data representative of the interacting partner atom distribution around surface amino acids of the protein;
storing the data in the protein atomistic non-covalent interacting database.

In another aspect of the invention, a method is provided for generating probability density maps of non-covalent interacting atoms for a query protein, the method comprising:
for each amino acid type of the query protein:
   determining data characterizing a conformation of each instance of the amino acid type in the query protein including determining a vector of torsion angle elements for each instance of the amino acid type in the is query protein; and
processing the data characterizing the conformation determined for each instance of each type of amino acid for the query protein to identify clusters of amino acid instances having similar conformation characteristics: for each atom of the query protein:
   determining an atom type of the atom, a parent amino acid of the atom, and a cluster to which the parent amino acid is a member; querying a protein atomistic non-covalent interacting database to retrieve data based on the atom type of the atom, the parent amino acid of the atom, and the cluster to which the parent amino acid is a member characterizing a non-covalent interaction of the atom with each atom type of a plurality of interacting atom types;
processing the retrieved data for each atom of the query protein to determine a probability of each interacting atom type interacting with an atom on the surface of the query protein; and
generating a probability density map for each interacting atom type based on the determined probability.

The methods of the invention can be used to predict functional binding sites in a protein. For example, such functional binding sites can be protein to protein interaction (PPI) sites, protein to polypeptide interaction sites, protein to carbohydrate interaction sites, protein to nucleic acid interaction sites, protein to small molecule interaction sites, protein to nucleotide interaction sites, and protein to ion (e.g., Ca²⁺, Mg²⁺, Zn²⁺, Mn²⁺, Cu²⁺) interaction sites.

Other features and advantages of the invention are apparent from the following description, and from the claims.

### BRIEF DESCRIPTION OF THE DRAWINGS

The invention description below refers to the accompanying drawings, of which:

FIG. 1 is a computer environment in which the principles of the present invention may be implemented.

FIG. 2 is a system for generating a functional site prediction model database.

FIG. 3 is a system for predicting functional sites of biological molecules.

### DETAILED DESCRIPTION

FIG. 1 is an exemplary block diagram of an exemplary computer environment 100 that may be used with one or more embodiments described herein. The computer environment 100 illustratively comprises of a client 105 operatively interconnected to a network. The network is also operative interconnected with a computer 115. As will be appreciated by those skilled in the art, a computer network is a geographically distributed collection of entities interconnected by communication links and segments for transporting data between end nodes, such as personal computers and workstations. Many types of networks are available, with the types ranging from Wi-Fi networks, cell phone networks, local area networks (LANs) to wide area networks (WANs). Wi-Fi is a mechanism for wirelessly connecting a plurality of electronic devices (e.g., computers, cell phones, etc.). A device enabled with Wi-Fi capabilities may connect to the Internet via a wireless network access point, as know by those skilled in the art. Cellular networks are radio network distributed over land areas called “cells”, wherein each cell may be served by at least one fixed-location transceiver known as a cell site or base station. When joined together, these cells may provide radio coverage over a wide geographic area. As known by those skilled in the art, this may enable a large number of portable transceivers (e.g., mobile phones) to communicate with each other. LANs typically connect the entities over dedicated private communications links located in the same general physical location, such as a building or campus. WANs, on the other hand, typically connect geographically dispersed entities over long-distance communications links, such as common carrier telephone lines, optical light paths, synchronous optical networks (SONET), or synchronous digital hierarchy (SDH) links. The Internet is an example of a WAN that connects disparate networks throughout the world, providing global communication between entities on various networks. The entities typically communicate over the network by exchanging discrete frames or packets of data according to predefined protocols, such as the Transmission Control Protocol/Internet Protocol (TCP/IP), Hypertext Transfer Protocol (HTTP). In this context, a protocol consists of a set of rules defining how the entities interact with each other and how packets and messages are exchanged.

The computer 115 may comprise of a network interface 120, one or more processors 125, a memory 130 and a storage controller 135 interconnected by a system bus 140. The network interface 120 contains the mechanical, electrical, and signaling circuitry for communicating data over physical links coupled to the network. The network interface may be configured to transmit and/or receive data using a variety of different communication protocols, as known by those skilled in the art.

The memory 130 comprises a plurality of locations that are addressable by the processor(s) 125 for storing software programs and data structures associated with the embodiments described herein. The processor(s) 125 may comprise necessary elements or logic adapted to execute the software programs and manipulate the data structures. Illustratively, the memory 130 would contain an operating system (OS) (not shown) that would be executed by the processor 125 to manage the computer. Illustratively, memory stores a prediction model generation module 200, described further below in reference to FIG. 2, and a biomolecule to biomolecule interaction site inference (B2BISI) module 300, described further below in reference to FIG. 3.

The memory may further include a web server 160. The web server 160 delivers/serves up web pages to clients 105 via network 110 to enable access to embodiments of the present invention. For example, the web server 160 of the computer 115 may utilize a client/server model and the World Wide Web's Hypertext Transfer Protocol (HTTP) to enable users on clients 105 to access the system in accordance with embodiments of the present invention.

It will be apparent to those skilled in the art that other types of processors and memory, including various computer-readable media, such as non-transitory computer readable medium, may be used to store and execute program instructions pertaining to the techniques described herein. Also, while the embodiments herein are described in terms of processes or services stored in memory, alternative embodiments also include the processes described herein being embodied as modules consisting of hardware, software, firmware, or combinations thereof.

The storage controller 135 controls access to a storage device 145. Exemplary storage device 145 may comprise a disk drive, array of disk drives, flash memory or the like. It should be noted that the storage device 145 may comprise locally attached storage or remote storage that may be serviced by an intermediate device, such as a file server (not shown). As such, the description of storage device 145 being directly attached to computer 115 should be taken as exemplary only. Storage device 145 illustratively stores a database 150, described further below in reference to FIG. 2 that stores data representative of a number of biomolecules. Exemplary storage device 145 may also comprise a prediction model database 155, described further below in reference to FIG. 2.

A computational platform (named ISMBLab: In Silico Molecular Biology Lab—available on the World Wide Web at ismblab.genomics.sinica.edu.tw) is disclosed that is capable of predicting functional sites on protein surfaces starting from the experimental or model protein structures.

To bridge the ever-expanding gap in functional annotation for the genomic sequences, the ISMBLab platform will predict the putative surface sites on the model protein structures that could recognize proteins, peptides, carbohydrates, DNA, RNA, metal ions, small molecules, and other ligands, providing key functional information at the atomic level resolution that has not been attainable so far for the protein sequences of unknown function. Together, these predictions infer the putative functions of the protein structural models, leading to functional annotations for the query protein sequences. In summary, the ISMBLab promises to be the core technical platform for the most complete structure-based functional prediction database for the current 20 million model structures and projects to accommodate the rapid expansion of the model structure databases following the expansion of genomic sequence databases.

The main novel features of the invention include databases for interacting atoms on protein surfaces, three-dimensional probability density maps of interacting atoms on protein surfaces, protocols for machine learning, prediction of functional sites, prediction confidence level evaluation, integration of the prediction results. One key innovation is the general applicability of the functional site prediction to all biologically relevant ligands: proteins, peptides, carbohydrates, DNA, RNA, metal ions, small molecules, and other ligands. Protein function prediction accuracy is associated with accurate predictions on all possible ligands interacting with the query protein. The ISMBLab platform provides the most complete predictions for all ligand types with accurate prediction results.

The key features are itemized below:

(1) A novel method has been developed to construct three dimensional probability density maps (PDM) for interacting atoms on protein surfaces.

(2) The interpretation of the 3-D PDM into numeric values which describe atomistic preference of protein surface patches has been validated.

(3) Protein interior information is applied to binding site predictions. Benchmarks show that the protein interior information can improve the predictive performance.

(4) A novel method for clustering amino acids conformations is applied for both database construction and PDM building.

(5) Amino acids are classified into 30 atom types and the machine learning models are trained independently. A numeric method to normalize each models output for prediction confidence has been validated to combine prediction results from different atom type predictions.

Advantages when Compared to Existing Technologies

(1) In contrast to the sequence/structure-based protein function predictors (see above), this method can avoid the problem when no homology or functional site similarity is available for comparison.

(2) The protein surface features described by the three dimensional density maps are more relevant in inferring protein recognition surfaces, and thus make the computational predictions more accurate.

(3) The computational predictions based on the three dimensional probability density maps also identify the key residues with higher probability to interact with perspective ligands, leading to further information for engineering protein functionalities.

(4) Each atom type is predicted by corresponding predictors. The separation improves performance. According to previous studies for protein interfaces, contributions of binding energy for atoms in interfaces are not equal. Some types of amino acids contribute more binding energy; these kinds of amino acids are named interaction hot spots. The benchmark shows that atom types which are frequently observed in interaction hot spots have a higher predictive power. The overall binding site predictor combines all prediction results from all atom types. Therefore, high confidence predictors enhance the overall performance of the disclosed method.

One of the important applications of the disclosed method is to predict the function of antibodies. Antibodies are able to bind to many kinds of molecules. Since experimental identification of antibody function can only be done in low throughput, a computational-based method of identifying functional antibodies can assist in antibody discovery and development. For example, high-throughput sequencing for finding antibodies has been proposed, experimental methods have difficulties to examine all antibodies. Computation-based antibody function predictions can help to categorize large amount of antibodies based on function which could help further in experimental studies. All these applications have not been demonstrated in previously existing technologies. The current invention thus has great advantage in leading to multiple important applications in protein engineering and protein bioinformatics.

Another aspect of the invention is to develop functional annotation for genomics protein sequences of unknown functions. The functional information can provide crucial information regarding drug target validation, biomarker discovery, and many genomics and proteomics applications.

### Other Aspects of the Invention are Listed Below:

(1) Protein engineering: ISMBLab platform can be used to identify functional sequences for further experimental design. The functional regions in proteins can be designed by modeling mutations and then predicting the functional features of the models with the ISMBLab predictors. This computational screening process can be applied to as many models as needed to reduce the functional design sequence space, providing a tractable approach to optimizing proteins for molecular recognition. The application is particularly feasible for antibody engineering: virtual computational screening of functional antibody sequences can lead to design of synthetic antibody libraries that are much more effective in discovering antibody leads against target molecules in comparison with trial-and-error approaches.

(2) Antibody function prediction: High-throughput sequence technologies such as 454 pyrosequencing or Illumina sequencing have been used to profile antibody sequences from individuals to discover valuable antibodies against diseases. Identifying antibody functions from the sequence data is a great challenge. Structure models of antibody sequences can be built and evaluated by all predictors in ISMBLab to predict potential binders.

Specific aspects of the invention are described below.

### 1 Training Phase

Referring to FIG. 2, a prediction model generation system 200 receives a database 150 including data representative of a number of biomolecules (i.e., P₁, P₂, . . . Pₓ) with known biomolecule-to-biomolecule binding sites (each datum referred to as a “known biomolecule”). The system 200 processes the data in the database 150 to train a number of prediction models 210 which are stored in a prediction model database 155 for later use.

The system 200 includes probability density model (PDM) generation module 204, an attribute calculation module 206, and a machine learning module 208. The PDM generation module 204 receives the data representative of the known biomolecules and, for each known biomolecule generates a number of three dimensional PDMs (PDM₁, PDM₂, . . . PDM_{J}). The number, J, of PDMs is determined by a number of “atom types.” Each PDM represents a probability of a non-covalent interacting atom on a surface of the known biomolecule interacting with a different one of the atom types.

The probability density maps for all of the known biomolecules are passed to the attribute calculation module 206 which, for each known biomolecule, calculates a number of attributes using, for example, the equation:

$${A}_{i , j} = {S}_{i , j} + \frac{{\sum }_{k}^{{d}_{i , k} \leq 10 A} {S}_{k , j} \times {d}_{i , k}^{- 2}}{{\sum }_{n}^{{d}_{i , n} \leq 10 A} {d}_{i , n}^{- 2}}$$

Where i is the i^{th} atom on the surface of the known biomolecule, j is the i^{th} atom type, and

$${s}_{i , j} = {\sum }_{k}^{{r}_{i , k} \leq 5 A} {g}_{k , j}$$

The attributes for all of the known biomolecules are passed to the machine learning module 208 which processes the attributes using a machine learning computation to train a prediction model 210 for each of the J atom types. The prediction models 210 are stored in the prediction model database 155 for later use.

### 2. Inference Phase

Referring to FIG. 3, a biomolecule-to-biomolecule interaction site inference system 300 receives a prediction model database 155 (such as the prediction model database 155 of FIG. 2) and data representative of a query biomolecule 314 (i.e., a biomolecule with unknown biomolecule-to-biomolecule interaction sites). In some examples, the data representative of the query biomolecule 314 includes structural information of the query biomolecule. The biomolecule-to-biomolecule interaction site inference system 300 processes the data representative of the query biomolecule 314 using the prediction model database 155 to generate a biomolecule-to-biomolecule interaction site prediction 316.

The biomolecule-to-biomolecule interaction site inference system 300 includes a number of predictors 318 and an integration module 320. In some examples, the biomolecule-to-biomolecule interaction site inference system 300 includes a single predictor 318 for each atom type. Each predictor 318 is configured by a different model 310 of a number of models included in the prediction model database. Each predictor receives the data representative of the query biomolecule 314 and, for each surface atom of the query biomolecule 314 predicts the likelihood that the surface atom belongs to a biomolecule-to-biomolecule interaction site. In some examples, the outputs of the predictors 318 are normalized using a confidence value.

The outputs of the predictors 318 are provided to the integration module 320 which predicts the biomolecule-to-biomolecule interaction site by selecting surface atoms of the query biomolecule with high confidence levels and using those surface atoms as seed atoms for a clustering operation. In some examples, parameters of the clustering operation are determined during the training phase. The output of the clustering operation is the predicted biomolecule-to-biomolecule interaction site 316.

### 3. Implementations

Systems that implement the techniques described above can be implemented in software, in firmware, in digital electronic circuitry, or in computer hardware, or in combinations of them. The system can include a computer program product tangibly embodied in a machine-readable storage device for execution by a programmable processor, and method steps can be performed by a programmable processor executing a program of instructions to perform functions by operating on input data and generating output. The system can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

Additional details for carrying out the above-described method have been documented in the following publications: Keng-Chang Tsai et al, (2012) PLoS ONE 7(7): e40846. doi:10.1371/journal.pone.0040846, Ching-Tai Chen et al. (2012) PLoS ONE 7(6): e37706. doi:10.1371/journal.pone.0037706, and Chung-Ming Yu et al., PLoS ONE 7(3): e33340. doi:10.1371/journal.pone.0033340. The contents of the foregoing publications are incorporated herein by reference in their entirety.

Without further elaboration, it is believed that one skilled in the art can, based is on the disclosure herein, utilize the present invention to its fullest extent. The following specific examples are, therefore, to be construed as merely descriptive, and not limitative of the remainder of the disclosure in any way whatsoever. All references cited herein are hereby incorporated by reference in their entirety.

### Example 1

### Database for Non-Covalent Interacting Atom Pairs in Proteins

A database for non-covalent interacting atom pairs in proteins was developed and organized according to parent amino acid conformational types. Amino acid conformations were clustered into a limited set of clusters for each type of amino acid by assigning torsion angles to each of the amino acids in available protein structures with known computational tools. For each type of amino acid from the protein structure entries in the Protein Data Bank (PDB), a set of vectors with torsion angle elements in degrees was established. The vectors can be represented by {φ, ψ, χ₁, . . . , χᵢ} where φ, ψ are backbone torsion angles and χᵢ are sidechain torsion angles as conventionally defined. The vectors were used as input to a fuzzy c-means algorithm for clustering. The number of the clusters was determined as the minimal integer satisfying the condition that increasing the number of clusters beyond this minimal integer made little change to the partition index and separation index, two fuzzy c-means algorithm indexes describing the relative mean distance within and between clusters. To augment the optimal decision on cluster numbers, we calculated the distribution of the intra-cluster root mean squared deviation (RMSD) in Å for superimposed amino acid structures between cluster members and the centroid conformation within a cluster for each cluster sets. The convergence of this intra-cluster RMSD to a minimal RMSD provided a more structure-related reference in contrast to the torsion angle-based structural descriptors in determining the optimal cluster number. After the determination of the cluster numbers, the centroid conformation of each of the clusters was determined as the center of mass of the vectors in the cluster.

### Example 2

### Protein Atomistic Non-Covalent Interacting Database

Atomistic contact interactions in proteins of known structures were organized into a database containing non-covalent atomistic interaction information for atom pairs in protein structures. For each of the atoms in residue X of a protein, the non-covalent interacting atoms were recorded as described in Laskowski et al. (J. of Mol. Biol. 259: 175-201). Briefly, for each atom (P) in residue X, the relative location of the atom P was defined with two consecutive atoms R and Q, where R is covalently linked to P, and Q is covalently linked to R. Atom R was set at the origin of the reference coordinate system; atom P was located on the z-axis; atom Q was on the z-x plane of the reference coordination system. All non-covalent interacting atoms to atom P were recorded in the database with the reference coordination system.

Non-covalent atomistic interactions in protein interiors were calculated and organized into the atomistic interaction database. First, a protein structure was randomly separated into two parts by cleaving at a random peptide bond. Interface residues with a change in solvent accessible surface area (SASA) greater than 40% of the total SASA resulting from the separation of the two protein halves were considered as candidate non-covalent atomistic interactors. The SASA for each of the amino acid residues was calculated. The atoms from the other half of the proteins were only recorded as interacting with atom P when the pairwise distance between the two atoms was less than 5 Å. Atoms within 9 consecutive residues from the N and C terminal directions of atom P were excluded as interacting atoms to the atom P. After all the interface residues were surveyed, the protein structure was again randomly separated at a different cleavage site and the survey for the atomistic contact interactions of each of the interface residues was repeated. This process was repeated 40 times for each of the 9468 non-redundant protein structures in the PDB with less than 60% sequence identity to each other. After the survey on all the non-covalent interacting atom pairs, the database was organized into a large number of files; each file is specific to an amino acid type, a conformational type based on the torsion angle vector of the amino acid, an atom type in the parent amino acid, and the interacting atom type. Atoms in the 20 natural amino acids are assigned to one of the 30 interacting atom types found in proteins plus the crystal water oxygen as the 31^{st} atom type. See Laskowski et al. mentioned above.

Water oxygen distributions around the surface amino acids in 915 non-redundant protein structures solved to high resolution (resolution <1.5 Å, sequence identity less than 30%, different graph topology and subunit structure) were recorded with the same P-R-Q is reference coordination system and were stored in the same file system described above.

Water oxygens within a 3.2 Å radius, i.e., within hydrogen bonding distance, to the interacting amino acid atoms were recorded in the database. This database was used for evaluating the desolvation penalties and water-mediated interactions in protein-protein interaction interfaces.

### Example 3

### Probability Density Maps (PDM) of Non-Covalent Interacting Atoms for Protein Surfaces

A probability density map (PDM) of a non-covalent interacting atom type is a three-dimensional distribution of likelihood for the type of atom to appear around protein surface amino acids. PDMs were reconstructed from the interacting atom pair databases described above for the 31 interacting atom types.

To construct a PDM for an interacting atom type on a target protein surface, the method first computationally enclosed the target protein structure in a rectangular box, clearing the structure by a margin of at least 7 Å from all sides of the protein's edge. The three-dimensional rectangular box was then gridded with 0.5 Å per unit in three-dimensional space. This grid size was a balance between the resolution of the PDM and the computational resources needed for the PDM construction. The grid points enclosed within the Connolly surface (described in Connolly, J. of Applied Crystallography 16: 548-558) of the target protein were masked from assigning PDM. The torsion angles of sidechain and mainchain of all the amino acids in the protein structure were calculated as described in EXAMPLE 1 above. For each of the amino acid residues in the protein, the conformational type of the amino acid X was determined by the torsion angle vector, which had the least Euclidean distance to the centroid conformation of the assigned conformational cluster. With the assignment of the conformational type for each of the amino acids in the protein structure, the non-covalent interacting atoms around each atom P in the protein structure were allocated from the database according to the atom type of P, the assigned three-atom reference system P-R-Q as described in EXAMPLE 2 supra, the amino acid type of the parent residue containing atom P, and the conformational type of the parent amino acid. Interacting is atoms outside the sphere with the radius equal to the sum of the van der Waals radii of the interacting atom and atom P plus a tolerance of 0.5 Å were not included as the interacting atoms with atom P. The coordinates of the allocated interacting atoms were transformed to the coordination system of the protein structure and mapped around the protein surface. An atom of non-covalent interaction was mapped only once for which the distance of the atom to P was the shortest. Thirty-one PDMs were constructed from all the interacting atoms allocated for all the protein atoms in the protein structure.

PDMs were constructed by mapping the interacting atoms allocated from the database as described in the previous paragraphs to the 3D grid system. To construct the PDM, each of the interacting atoms was distributed to 8 nearest grid points; the portion of the distribution was normalized by the database redundancy and was inversely proportional to the square of the distance from the atom to the grid:

$${v}_{ji} = \frac{1}{{p}_{i} n} \frac{1 / {d}_{ji}^{2}}{{\sum }_{k = 1}^{8} 1 / {d}_{ki}^{2}} ,$$

where vⱼᵢ is the value to be accumulated at a nearest grid point j for interacting atom i; dⱼᵢ is the distance of grid point j to the center of the interacting atom i; grid points indexed k=1˜8 are the nearest grids to the atom i; n is the number of residues collected in the database for the amino acid in the target protein with the conformational type defined by the torsion angle vector; p, is the background probability for atom type i to appear in all protein structures (when calculating water oxygen PDM, p, equals to 1). The factor 1/n in the Equation is to normalize the interacting atom density according to one conformation for each of the residues in the target protein and the background probability p, is to normalize the PDM based on the appearance frequency of the atom type i in proteins (except for water oxygen). The PDM for each of the interacting atom types was additively accumulated to completion as each of the atoms in the target protein surface finished contributing to the PDMs.

### Example 4

### Protein-Protein Interaction (PPI) Site Prediction

The method described above in EXAMPLES 1-3 were used to identify patterns of PDMs specific to known PPI sites. The trained predictors for PPI sites were cross-validated with the training cases (consisting of 432 proteins) and were tested on an independent dataset (consisting of 142 proteins). The residue-based Matthews correlation coefficient for the independent test set was 0.423; the accuracy, precision, sensitivity, specificity were 0.753, 0.519, 0.677, and 0.779 respectively.

### Example 5

### Hotspot Prediction of Antibody Paratope

The hotspot prediction of antibody paratope is based on the protein-protein interaction confidence level (PPI_CL) prediction method described above. The prediction method was validated for three antibodies for which alanine scanning data is available. The first two antibodies are anti-hen egg white lysozyme antibody FvD1.3 and HyHEL-63. These two antibodies bind to different epitopes. The third antibody is an anti-VEGF and HER2 antibody which uses different CDR loops to interact with two antigens. The overall Matthews correlation coefficient (MCC) is 0.43 with hotspot residues defined by ΔΔG>1 kcal/mole. The accuracy, sensitivity, and specificity are 0.83, 0.41, and 0.95 respectively.

### Example 6

### Prioritization of Hotspot Sites for Synthetic Antibody Library Design

The PPI_CL provided by the method described above can be used to suggest the paratope site priority for hotspot replacements when designing a synthetic antibody library. The ranking process is done by first changing the target paratope site to tyrosine. Two adjacent sites in both the N terminal and C terminal direction are also changed to each of the other 19 natural amino acid types except cysteine. A total of 361 (19*1*19) models of all sequence combinations will be built for each site. The score of each site is the average of the PPI_CL values when the site is mutated to an aromatic residue (i.e., phenylalanine, tyrosine and tryptophan). A site with a high PPI_CL value after they are changed to aromatic residues is predicted to be a hotspot. The library can be designed by ranking residues by the PPI_CL values so as to avoid sites with high sequence requirements.

### Example 7

### Prediction of Carbohydrate Binding Sites on Protein Surfaces

Prediction of non-covalent carbohydrate binding sites on protein surfaces were based on a novel encoding scheme of the three-dimensional probability density maps describing the distributions of 36 non-covalent interacting atom types around protein surfaces. See Keng-Chang Tsai et al. mentioned above. One machine learning model was trained for each of the 30 protein atom types described above. The machine learning method predicted tentative carbohydrate binding sites on query proteins by recognizing the characteristic interacting atom distribution patterns specific for carbohydrate binding sites from known protein structures. The prediction results for all protein atom types were integrated into surface patches as tentative carbohydrate binding sites based on normalized prediction confidence level. The prediction capabilities of the predictors were benchmarked by a 10-fold cross validation on 497 non-redundant proteins with known carbohydrate binding sites. The predictors were further tested on an independent test set with 108 proteins. The residue-based Matthews correlation coefficient (MCC) for the independent test was 0.45, with prediction precision and sensitivity (or recall) of 0.45 and 0.49 respectively. In addition, 111 unbound carbohydrate-binding protein structures for which the structures were determined in the absence of the carbohydrate ligands were predicted with the trained predictors. The overall prediction MCC was 0.49. Independent tests on anti-carbohydrate antibodies showed that the carbohydrate antigen binding sites were predicted with comparable accuracy.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

From the above description, a person skilled in the art can easily ascertain the essential characteristics of the present invention, and without departing from the spirit and scope thereof, can make various changes and modifications of the present invention to adapt it to various usages and conditions. Thus, other embodiments are also within the claims.

What is claimed is:

1. A non-transitory computer readable medium comprising instructions for inferring one or more biomolecule-to-biomolecule interaction sites, the instructions, when executed by at least one processor, comprising functionality to:
receive data representative of a plurality of prediction models, each prediction model associated with a different atom type of a plurality of atom types and characterizing biomolecule-to-biomolecule interaction site specific patterns common to a plurality of three dimensional probability density maps, each three dimensional probability density map associated with a corresponding biomolecule of a plurality of biomolecules included in a training data set and representative of a probability of a non-covalent interacting atom on a surface of the corresponding biomolecule interacting with the atom type associated with the prediction model;
receive data representative of a query biomolecule including one or more unknown biomolecule-to-biomolecule interaction sites; and
infer the one or more unknown biomolecule-to-biomolecule interaction sites of the query biomolecule based on the data representative of the plurality of prediction models.

2. The non-transitory computer readable medium of claim 1 wherein each of the plurality of biomolecules included in the training data set is a member of a known protein-protein complex and the query biomolecule is a protein.

3. The non-transitory computer readable medium of claim 1 wherein each of the plurality of biomolecules included in the training data set is a member of a known protein-carbohydrate complex and the query biomolecule is a protein.

4. A non-transitory computer readable medium comprising instructions for generating prediction models for prediction of biomolecule-to-biomolecule interaction sites, the instructions, when executed by at least one processor, comprising functionality to:
receive training data including data representative of a plurality of biomolecules having known biomolecule-to-biomolecule interaction sites;
for each biomolecule of the plurality of biomolecules
generate a plurality of three dimensional probability density maps, each three dimensional probability density map representing a probability of a non-covalent interacting atom on a surface of the biomolecule interacting with a corresponding atom type of a plurality of atom types;
for each surface atom of a plurality of surface atoms of the biomolecule, calculate a plurality of attributes, each attribute associated with a different one of the plurality of atom types;
train a prediction model for each of the atom types of the plurality of atom types based on the attributes calculated for each biomolecule of the plurality of biomolecules.

5. The non-transitory computer readable medium of claim 4 wherein each of the plurality of biomolecules is a protein.

6. A non-transitory computer readable medium comprising instructions for determining clusters of amino acid conformations, the instructions, when executed by at least one processor, comprising functionality to:
for each protein of a plurality of proteins in a protein database:
for each amino acid type of a plurality of amino acid types:
determine data characterizing a conformation of each instance of the amino acid type in the protein including determining a vector of torsion angle elements for each instance of the amino acid type in the protein; and
process the data characterizing the conformation determined for each instance of each type of amino acid for each protein in the protein database to identify clusters of amino acid instances having similar conformation characteristics.

7. The non-transitory computer readable medium of claim 6 wherein the instructions to process the data characterizing the conformation determined for each instance of each type of amino acid for each protein in the protein database to identify clusters includes instructions to determine an optimal number of clusters.

8. The non-transitory computer readable medium of claim 6 further comprising instructions to identify a centroid of each of the identified clusters.

9. A non-transitory computer readable medium comprising instructions for building a protein atomistic non-covalent interacting database, the instructions, when executed by at least one processor, comprising functionality to:
for each protein of a plurality of proteins in a first protein database:
identify non-covalent interacting atom pairs at the protein interior;
for each atom of each identified pair of non-covalent interacting atoms:
determine data representative of an amino acid type associated with the atom, a conformational type associated with the atom, an atom type associated with the atom, an interacting atom type associated with the atom, and a spatial relationship between the atom and each of the interacting atom types;
store the data in the protein atomistic non-covalent interacting database;
for each protein of a plurality of proteins in a second protein database:
determine data representative of water oxygen distributions around surface amino acids of the protein; and
store the data in the protein atomistic non-covalent interacting database.
for each protein of a plurality of proteins in a protein-interacting partner database:
identify non-covalent interacting atom pairs where the pairs
include an atom at the protein surface and an atom in an interacting partner;
for each atom of each identified pair of non-covalent interacting atoms:
determine data representative of the interacting partner atom distribution around surface amino acids of the protein;
store the data in the protein atomistic non-covalent interacting database;

10. A non-transitory computer readable medium comprising instructions for generating probability density maps of non-covalent interacting atoms for a query protein, the instructions, when executed by at least one processor, comprising functionality to:
for each amino acid type of the query protein:
determine data characterizing a conformation of each instance of the amino acid type in the query protein including determining a vector of torsion angle elements for each instance of the amino acid type in the query protein; and
process the data characterizing the conformation determined for each instance of each type of amino acid for the query protein to identify clusters of amino acid instances having similar conformation characteristics:
for each atom of the query protein:
determine an atom type of the atom, a parent amino acid of the atom, and a cluster to which the parent amino acid is a member;
query a protein atomistic non-covalent interacting database to retrieve data based on the atom type of the atom, the parent amino acid of the atom, and the cluster to which the parent amino acid is a member characterizing a non-covalent interaction of the atom with each atom type of a plurality of interacting atom types;
process the retrieved data for each atom of the query protein to determine a probability of each interacting atom type interacting with an atom on the surface of the query protein; and
generate a probability density map for each interacting atom type based on the determined probability.

11. A system for inferring one or more biomolecule-to-biomolecule interaction sites, the system comprising:
a processor operatively interconnected with a first database and a second database, the first data base including data representative of a number of biomolecules and the second database including data representative of a plurality of prediction models, each prediction model associated with a different atom type of a plurality of atom types and characterizing biomolecule-to-biomolecule interaction site specific patterns common to a plurality of three dimensional probability density maps, each three dimensional probability density map associated with a corresponding biomolecule of a plurality of biomolecules included in a training data set and representative of a probability of a non-covalent interacting atom on a surface of the corresponding biomolecule interacting with the atom type associated with the prediction model; and
the processor configured receive data representative of a query biomolecule including one or more unknown biomolecule-to-biomolecule interaction sites and further configured to infer the one or more unknown biomolecule-to-biomolecule interaction sites of the query biomolecule based on the data representative of the plurality of prediction models.

12. A system for generating prediction models for prediction of biomolecule-to-biomolecule interaction sites, the system comprising:
a processor operatively interconnected with a first database and a second database, the first data base including training data including data representative of a number of biomolecules having known biomolecule-to-biomolecule interaction sites;
the processor configured to, for each biomolecule of the plurality of biomolecules, generate a plurality of three dimensional probability density maps, each three dimensional probability density map representing a probability of a non-covalent interacting atom on a surface of the biomolecule interacting with a corresponding atom type of a plurality of atom types;
the processor further configured to, for each surface atom of a plurality of surface atoms of the biomolecule:
calculate a plurality of attributes, each attribute associated with a different one of the plurality of atom types;
train a prediction model for each of the atom types of the plurality of atom types based on the attributes calculated for each biomolecule of the plurality of biomolecules; and
store the trained prediction model in the second database.

13. A system for determining clusters of amino acid conformations, the system comprising:
a processor operatively interconnected with a protein database;
the processor configured to, for each protein of a plurality of proteins in the protein database:
determine, for each amino acid type of a plurality of amino acid types, data characterizing a conformation of each instance of the amino acid type in the protein including determining a vector of torsion angle elements for each instance of the amino acid type in the protein; and
process the data characterizing the conformation determined for each instance of each type of amino acid for each protein in the protein database to identify clusters of amino acid instances having similar conformation characteristics.

14. A system for building a protein atomistic non-covalent interacting database, the system comprising:
a processor operatively interconnected with a first protein database, a second protein database and a protein-interacting partner database;
the processor configured to, for each protein of a plurality of proteins in the first protein database:
identify non-covalent interacting atom pairs at the protein interior;
wherein the processor is further configured to, for each atom of each identified pair of non-covalent interacting atoms:
determine data representative of an amino acid type associated with the atom, a conformational type associated with the atom, an atom type associated with the atom, an interacting atom type associated with the atom, and a spatial relationship between the atom and each of the interacting atom types;
store the data in the protein atomistic non-covalent interacting database;
the processor further configured to, for each protein of a plurality of proteins in a second protein database:
determine data representative of water oxygen distributions around surface amino acids of the protein; and
store the data in the protein atomistic non-covalent interacting database.
the processor further configured to, for each protein of a plurality of proteins in a protein-interacting partner database:
identify non-covalent interacting atom pairs where the pairs include an atom at the protein surface and an atom in an interacting partner;
the processor further configured to, for each atom of each identified pair of non-covalent interacting atoms:
determine data representative of the interacting partner atom distribution around surface amino acids of the protein; and
store the data in the protein atomistic non-covalent interacting database.
